(19) United States
(12) Patent Application Publication
(10) Pub. No.: US 2026/0246792 A1
(43) Pub. Date: Aug. 20, 2026

(54) SYSTEMS AND METHODS FOR GENERATING A HUMAN-INTERPRETABLE CONTEXT REPORT ASSOCIATED WITH ANOMALOUS COMPUTER NETWORK EVENT LOGS OF USERS

(71) Applicant: Capital One Services, LLC, McLean, VA (US)

(72) Inventor: Samuel Sharpe, Somerville, MA (US)

(73) Assignee: Capital One Services, LLC, McLean, VA (US)

(21) Appl. No.: 19/054,635

(22) Filed: Feb. 14, 2025

(51) Int. Cl. H04L 9/40

(52) U.S. Cl. CPC H04L 63/1425

(57) ABSTRACT

Systems and methods are described herein for generating a human-interpretable context report associated with anomalous computer network event logs of users. For example, the system receives a set of data packets comprising a set of computer network events associated with a first user. The system provides the set of computer network events as input to an artificial intelligence (AI) model to generate, (i) a first output identifying a subset of computer network events contributing to an identified anomaly associated with the set of computer network events and (ii) a second output indicating a context associated with the subset of computer network events, the first output being generated via a first portion of the AI model, the second output being generated via a second portion of the AI model. The system generates, for display on a user interface, a graphical representation of a context report associated with the identified anomaly.

### BACKGROUND

In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality may be complex and time-consuming. Additionally, data that is obtained may need to be categorized and labeled accurately, which may be difficult, time-consuming and a manual task. Second, despite the mainstream popularity of artificial intelligence, practical implementations of artificial intelligence may require specialized knowledge to design, program, and integrate artificial intelligence-based solutions, which may limit the amount of people and resources available to create these practical implementations. Finally, results based on artificial intelligence may be difficult to review as the process by which the results are made may be unknown or obscured. This obscurity may create hurdles for identifying errors in the results, as well as improving the models providing the results. These technical problems may present an inherent problem with attempting to use an artificial intelligence-based solution to generate human-interpretable descriptions of artificial intelligence-based decisions.

### SUMMARY

Methods and systems are described herein for novel uses and/or improvements to artificial intelligence applications. As one example, methods and systems are described herein for generating a human-interpretable context report associated with anomalous computer network event logs of users.

As artificial intelligence models, or AI models, are implemented to more and more facets of day-to-day life, there is the desire to understand how an AI model arrives at its answer. However as AI models continue to process larger and more complex data, it becomes more difficult to generate a human-interpretable explanation of how the AI model generated its answer based on the data it processed.

Existing systems may employ various interpretability techniques in an attempt to facilitate understanding as to an explanation on how an AI model generated a response or other prediction. These interpretability techniques may identify which input features in an AI model contribute to the model's prediction, such as Shapley values. Despite such interpretability techniques shedding light onto an impact value of input features (e.g., a degree or other level of impact that an input feature has on a given prediction), these methods fail to provide a human-interpretable context reflecting why a given prediction was generated. For example, such values are keyed towards individual input features relative impact on a given prediction, as opposed to a human-interpretable, underlying reason as to why the prediction occurred. In other words, existing interpretability systems merely provide arbitrary numerical values that rank input feature importance relative to a given prediction as opposed to human-interpretable explanation of characteristics of the input data features itself regarding what caused the prediction to occur. This interpretation by specialized data analysts or computer scientists, which leads to inconsistent evaluations as to why a given prediction was generated as each interpretation is unique to the analyst/scientist interpreting the Shapley values. As regulations regarding the use of AI come into play that require explanations regarding how AI systems generate predictions or other responses, such inconsistent evaluations may cause confusion or other non-compliance issues. Furthermore, as AI system use expands to non-specialized users (e.g., laypersons) there is a need for non-abstract human-interpretable explanations regarding AI-derived predictions.

To overcome these technical deficiencies, the system may determine cluster labels (e.g., descriptions) associated with data points (e.g., input features) contributing to a prediction to provide a generalized, human interpretable, explanation of a prediction an AI model has generated. For example, in connection with generating a prediction via an AI model (e.g., an anomaly prediction), the system may generate (i) a first output indicating a subset of computer network events that contributed to an identified anomaly, and (ii) a second output indicating a cluster context associated with the subset of computer network events to which the subset of computer network events belong. By doing so, the system may use a generalized cluster label indicating a context of data belonging to the cluster to generate a human-interpretable, domain-specific, explanation as to why a given prediction was generated. Furthermore, by leveraging such cluster labels as opposed to arbitrary manual analysis via data analysts, the system facilitates consistent explanations (e.g., context) as to why AI-derived predictions have occurred, thereby mitigating incongruity between AI-prediction explanations/evaluations, and provides a standardized reference point that anyone, such as laypersons, may understand.

For example, the system may receive a computer network log file to identify an anomaly associated with the computer network log file. The computer network log file may include a set of computer network events indicating various events associated with the computer network such as log in attempts, database access requests, times stamps of the given events, user upload/downloads, or other computer events that may occur with respect to the use of a computer. The system may then provide the set of computer network events to an AI model to generate, via the AI model, based on the set of computer network events (i) a first output identifying a subset of computer network events contributing to an identified anomaly associated with the set of computer network events and (ii) a second output indicating a context associated with the subset of computer network events. For instance, the system may determine a subset of computer network events (e.g., of the set of computer network events) that contributed to an identified anomaly generated via the AI model. For example, the system may determine a subset of computer network events of the set of computer network events (e.g., provided as input to the AI model) that satisfy a threshold contribution value to the detected anomaly. By doing so, the system may determine which computer network events of the set of computer network events contributed the most to the detected anomaly.

The system may also determine the second output based on clusters to which the input data has been clustered into. To provide a human-interpretable context report that enhances user understanding regarding AI-derived predictions, the system may cluster (or otherwise assign) the computer network events to one or more clusters. Each cluster may indicate a grouping similar input features (e.g., computer network events) and the cluster label may indicate shared characteristics (e.g., a context, a domain-specific context) of the inputted features in each cluster. For example, log in attempts may be one cluster and unauthorized users may be a second cluster. Assigning each inputted value into a cluster may also reduce the complexity and dimensionality of large datasets, improving computational efficiency. The system may identify the clusters to which the subset of computer network events belong and extract the cluster label(s) associated with the respective clusters. By doing so, the system determines a context (e.g., based on the cluster labels) of the input features that contributed to the identified anomaly to be used in generating a context report reflecting a human-interpretable, standardized, explanation as to “why” an anomaly is detected.

For example, the system may generate a graphical representation of a context report using the first and second outputs obtained via the AI model to facilitate human interpretable explanations of the predictions. The context report may include an indication of (i) the identified anomaly, (ii) the subset of computer network events contributing to the identified anomaly, and (iii) a context associated with the subset of computer network events. As opposed to existing systems that merely provide a level of importance for input features, the system enhances user-understanding of AI-derived predictions by leveraging domain-specific, generalized, contextual information of the input features as whole. That is, as opposed to merely providing overly granular contribution values indicating feature importance alone, the system provides high-level human-interpretable context that captures an overall theme(s) or reason(s) as to why an AI-derived prediction (or other output) has occurred based on characteristics of the data contributing to the AI-derived prediction. By doing so, the system negates the need to have data analysts or engineers interpret datapoint-specific values, but rather enables any person (e.g., laypersons, consumers, etc.) to view quickly understand the underlying reasons as to why an AI-derived prediction occurred—thereby enhancing the user experience. Furthermore, in this way, the system provides standardized explanations as to why a given AI-derived prediction occurred via the cluster labels corresponding to the subset of computer network events that contributed to the identified anomaly—thereby mitigating the inconsistent data analyst-derived interpretations of existing systems.

In some aspects, methods and systems for generating a human-interpretable context report associated with anomalous computer network event logs of users is provided. For example, the system may receive a set of data packets, over a first computer network, comprising a set of computer network events associated with a first user. The system may provide the set of computer network events as input to an artificial intelligence (AI) model to generate, based on the set of computer network events, via the AI model, (i) a first output identifying a subset of computer network events contributing to an identified anomaly associated with the set of computer network events and (ii) a second output indicating a context associated with the subset of computer network events, the first output being generated via a first portion of the AI model, the second output being generated via a second portion of the AI model that is different from the first portion of the AI model. The system receives, from the AI model, the first output within a threshold time period of the second output. The system generates, for display on a user interface of a user device, a graphical representation of a context report associated with the identified anomaly based on the first output and the second output. The system may then transmit, over the first computer network, the graphical representation the context report to the user device.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for generating a human-interpretable context report, in accordance with one or more embodiments.

FIG. 2 shows an illustrative diagram of an artificial intelligence model generating one or more outputs, in accordance with one or more embodiments.

FIG. 3 shows an illustrative diagram of one or more graphical representations of the one or more outputs generated by an artificial intelligence model, in accordance with one or more embodiments.

FIG. 4 shows illustrative components for a system used to generate a human-interpretable context report associated with anomalous computer network event logs of users, in accordance with one or more embodiments.

FIG. 5 shows a flowchart of the steps involved in generating a human-interpretable context report associated with an anomaly, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

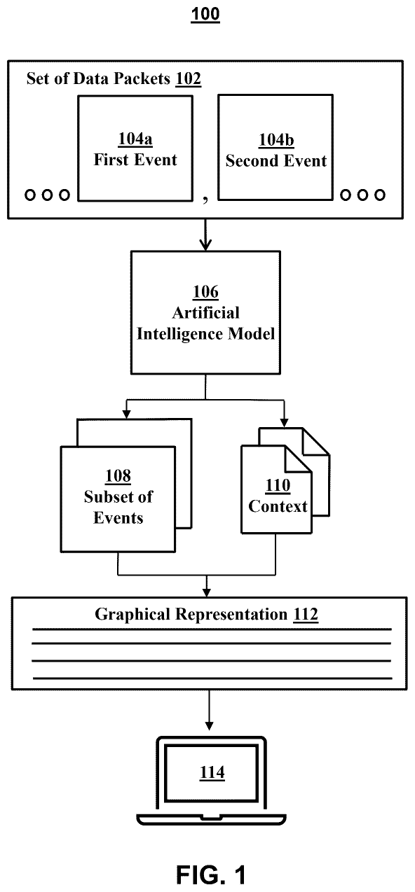

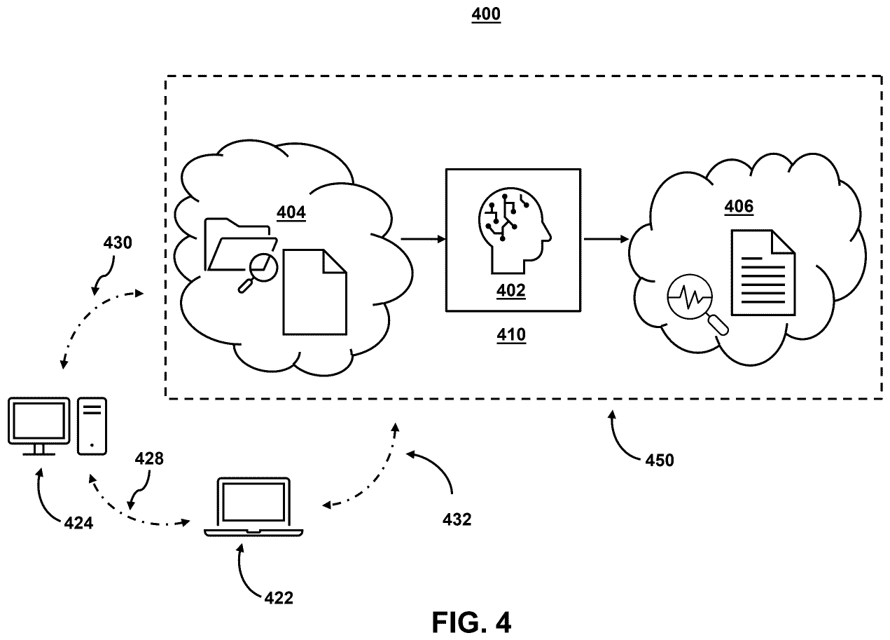

FIG. 1 shows an illustrative diagram for generating a human-interpretable context report, in accordance with one or more embodiments. For example, FIG. 1 shows a diagram 100 for generating a human-interpretable context report associated with a computer log. Diagram 100 may represent an illustrative flow diagram showing processing the computer log to determine an anomaly associated with the computer log and generating a human-interpretable context report explaining how the anomaly was determined. For example, one or more of the components or operations associated with such components may be performed by one or more components of system 400 (FIG. 4).

For example, the system (e.g., system 400 (FIG. 4)) may receive a set of data packets 102. For example, set of data packets 102 may be provided by a user device associated with a user. Set of data packets 102 may be received over a computer network. For example, set of data packets 102 may be transmitted over the internet, a local area network, or another wired or wireless computer network. Set of data packets 102 may include a set of computer network events 104 associated with a first user. For example, the first user may be the user associated with the user device. Set of computer network events 104a-104b may include a first event 104a, a second event 104b, or one or more other events (not shown). For example, although set of computer network events 104 show two events, it should be noted that set of computer network events 104a-104b may include any number of computer network events, in accordance with one or more embodiments. Set of computer network events 104 may be a streamed time-series data set. For example, as the user performs one or more actions, each action may be received by the system in real, or near real, time based on the user's performance of such actions. The system may actively monitor the user device for set of computer network events 104 to identify anomalous events associated with set of computer network events 104 and to generate human interpretable explanations of the anomalous events as computer network events 104 occur.

The system may provide set of computer network events 104 as an input to an artificial intelligence (AI) model 106. For example, AI model 106 may comprise one or more portions. For example, AI model 106 may include a first portion, a second portion, or a third portion. A first output may be generated via the first portion of the AI model, a second output may be generated via the second portion of the AI model, and the third output may be generated via a third portion of the AI model (as will be explained later). For example, AI model 106 include multiple portions that work together to identify one or more anomalies, subsets of computer network events, contexts associated with the subset(s) of computer network events, or other information. The system may extract set of computer network events 104 from set of data packets 102. The system may generate, via AI model 106, a first output identifying a subset of computer network events 108. For example, within a threshold time period (e.g., one millisecond, two milliseconds, one second, etc.) of AI model 106 generating a prediction (e.g., determines whether an anomaly exists, detects a given anomaly, etc.), the system may identify subset of computer network events 108 contributing to the anomaly associated with set of computer network events 104. For example, the system may identify a subset of computer network events 108 relating to an anomaly of unauthorized account use. The system may additionally generated, via AI model 106, a second output indicating a context 110 associated with subset of computer network events 108. For example, AI model 106 may generate context 110 including a human-interpretable, generalized explanation associated with the subset of computer network events 108 to facilitate understanding as to why the anomaly was identified or otherwise determined.

The system may generate a graphical representation 112 of a context report. Graphical representation 112 of the context report may be associated with the identified anomaly based on outputs obtained from AI model 106. For example, graphical representation 112 of the context report may include an indication of the subset of computer network events 108, context 110, an identified anomaly, or other information. Graphical representation 112 of the context report may be generated for display on a user interface of a user device 114 (e.g., a user terminal). Additionally or alternatively, the system may transmit graphical representation 112 of the context report to user device 114. For example, the system may transmit graphical representation 112 of the context report over the first computer network.

User device 114 may be a computer workstation, a client terminal, a remote or local interface, or any other type of user interface device. The user device 114 may be a stationary terminal or a mobile device. For example, the user device 114 may be a desktop computer, a computer server with a user interface, a laptop computer, a tablet, a smartphone, a PDA, or any other type of mobile or non-mobile device. User device 114 may include a user interface. The user interface may be a screen of user device 114. A user may interact with the user interface. The user may interact with the user interface using various input devices. The input devices may include a mouse, a keyboard, a touchscreen, voice control, etc.

As described herein, set of computer network events 104 may include one or more events occurring within a computer. A computer network event may be dependent on any variable that changes over time. The system may track a variable (e.g., state, value, amount, price) of an asset (e.g., item, security, event) over time. A variable being tracked by the system changing may be a computer network event. For example, a variable may change from a first state to a second state, or from a first value to a second value. The system may receive set of data packets 102 including set of computer network events 104 in response to the variable changing.

Set of computer network events 104 may include a series of events occurring within a computer. For example, set of computer network events 104 may include a series of variable changes that are tracked by the system. A computer network events of set of computer network events 104 may include event information. For example, the event information may include a computer network event identifier, an entity identifier, a value, a timestamp, or other event-related information. For example, in a cybersecurity embodiment, the computer network event identifier may indicate an event type, which may be a name for the event type or a numerical representation of the event type (e.g., a serial number, hash value, etc.), or other indication of an event type. For instance, the event type may be a login attempt, an application event (e.g., opening an application, accessing an application, etc.), a database access attempt, downloading/uploading a computer file, or other computer-related events. The entity identifier may indicate a user related to the computer network event. For example, the entity identifier may indicate a user identifier associated with the computer network event. As another example, the value may represent an amount of data communicated with respect to the computer network event, an amount of time associated with the event (e.g., how long the user took to log in, how long the user accessed a database, how long the user took to download a file, etc.).

In a financial services embodiment, a computer network event (e.g., an event of set of computer network events 104) may be a financial event related to an account of a user. For example, in such a case, computer network event may be a transaction, an update to financial account related information (e.g., address, telephone number, email address, account preferences, password, etc.), a loan request, a new account being opened, closure of an account, a wire transfer, a payment, a new user authorization, a user deauthorization, a freezing of an account, an unfreezing of the account, a reposting of a transaction, an account balance update, a return of an item, a refund, or other financial-account activity related events. In such embodiment, the computer network event identifier may be an identifier indicating the respective computer network event. For example, where the computer network event type is a transaction, the computer network event identifier may be “transaction” or may indicate a numerical representation indicating that the computer network event was a transaction. The entity identifier may be an identifier indicating an entity associated with the computer network event. For example, the entity identifier may indicate a company identifier, a financial service provider identifier, merchant identifier, location identifier (e.g., location of the merchant), a loan servicer identifier, a user associated with the computer network event (e.g., the user associated with the account, account number, account name), a system identifier (e.g., an identifier indicating a system that enacted the computer network event), or other entity identifier. The value may include one or more values associated with the computer network event. For example, the one or more values may be associated with an amount of credit card usage (credit utilization), a transaction amount, cardholder information (e.g., a card number, a card expiration date, etc.), a balance, a payment amount, a credit limit, a loan amount or other value associated with the computer network event. The timestamp may include a date and/or time associated with one or more events of computer network events. For example, the timestamp may indicate a time at which the computer network event has occurred. In some embodiments, one or more computer network events may be associated with, or contribute to, an anomaly.

As described herein, an anomaly may refer to a prediction. For example, in some embodiments, an anomaly may be a prediction indicating an irregularity, inconsistency, or deviation from a norm. For instance, an anomaly may be an indication that one or more event(s), characteristic of an event(s), summary of event(s), or other information exhibits unexpected behavior. An anomaly may be identified based on one or more computer network events 104. For example, in a cybersecurity embodiment, one or more computer network events 104 may include information indicating unverified access to a user account (e.g., an anomaly). As another example, based on the one or more computer network events, the AI model 106 may generate an output indicating an anomaly reflecting “security breach,” “unauthorized user,” “man-in-the-middle attack,” or other output indicating irregular behavior. In a financial services embodiment, an anomaly may indicate irregular behavior associated with a financial account of a user. For example, the anomaly may be respective to the user's normal financial activities, or may be respective to other users normal financial activities. For instance, the AI model 106 may be trained on a large corpus of financial account events of various users to detect anomalous behavior of a given user with respect to other users. In some embodiments, however, the AI model 106 may be trained on a corpus of financial account events of a given user to detect anomalous behavior of a given user's financial account events. In the financial services embodiment, computer network events 104 may be a set of transactions, where one or more of the transactions may include information indicating a stolen credit card, fraud occurring, or other unexpected events. In some embodiments, an anomaly may be a prediction generated by AI model 106 that indicates a given classification of one or more of computer network events 104 that are inconsistent/irregular with respect to a norm. For example, the AI model 106 may generate a prediction indicating “fraud detected,” “high credit risk,” or “high marketing value” based on a subset of the set of computer network events 104.

As described herein context 110 may include a human interpretable explanation, categorization, summary, or characteristic. For example, context 110 may be used to define a shared characteristic of one or more computer network events. For example, context 110 may be used to explain why AI model 106 identified an anomaly associated with subset of computer network events 108. For example, context 110 may be a label (e.g., generated based on a set of computer network event information, provided by a user, etc.) assigned to a cluster. For instance, the system may assign or label clusters with context 110 to indicate that computer network events that are part of a given cluster share a given characteristic (e.g., context 110). This in turn may provide human understandable context as to why a given prediction generated by AI model 106 was generated based on events (e.g., computer network events 108) that contributed to the prediction. For example, in a cybersecurity embodiment, AI model 106 may generate a prediction indicating a security breach (e.g., an anomaly). To provide the user an explanation as to why the AI model 106 generated the prediction, the system may determine that one or more events (or embeddings of such events) that contributed to the prediction (e.g., that satisfy a threshold contribution value, a threshold Shapley value, etc.) are part of a cluster labeled with a context of “unauthorized resource access.” As such, the system may generate for display, not only the prediction (e.g., security breach) but may also provide the context 110 for which the prediction is based on (e.g., “unauthorized resource access). By doing so, the system may enhance the user experience as non-specially trained users may understand why a given prediction was generated via context 110.

As another example in a financial services embodiment, the context 110 may be a cluster label assigned to, or generated, based on computer network events (e.g., transactions, financial account activity data, or other financial-event data) that are part of a given cluster. For example, AI model 106 may be configured to cluster transactions. After clustering the transactions, the system may then assign (e.g., via a user, or automatically generate) labels to be assigned to those clusters indicating a context 110 of the transactions (or other financial-event related data) part of respective cluster. For example, the system may generate a set of clusters, where each cluster includes transactions. The transactions may be clustered (e.g., grouped) based on the transaction information of each transaction. As an example, the generated set of clusters may be labeled with a context, such as “high dollar amount transactions,” “low dollar amount transactions,” “luxury good transactions,” “grocery transactions,” “restaurant transactions,” “gas station transactions,” “multimedia subscription transactions,” or other clusters labels based on the transactions part of those clusters. As such, when the AI model 106 generates a prediction such as “fraud detected,” the system may determine (i) which individual events contributed to the prediction and (ii) based on the individual events contributing to the prediction, which cluster they belong to. Upon determining which cluster the individual events contributing to the prediction belong to, the system may generate for display a message the comprises (i) the prediction (e.g., fraud detected) and (ii) the context explaining why the prediction was generated (e.g., “high dollar amount transactions”). In this way, the system enhances the user experience as laypersons are able to quickly and efficiently understand why the AI model 106 generated a given prediction.

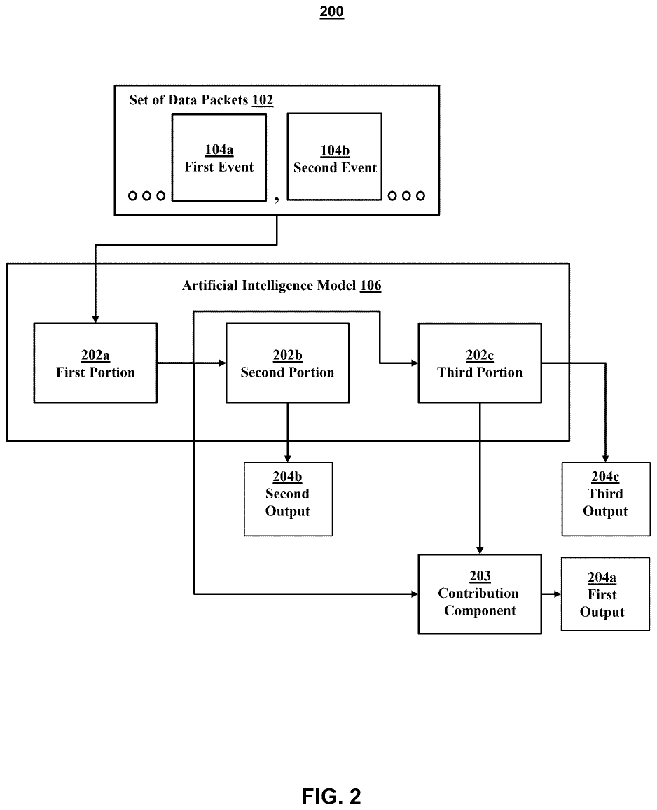

FIG. 2 shows an illustrative diagram of an artificial intelligence model generating one or more outputs, in accordance with one or more embodiments. For example, diagram 200 shows AI model 106 generating one or more outputs 204a-204c. AI model 106 may include, for example, model portions 202a-202c, such as a first portion 202a, a second portion 202b, a third portion 202c, or other portions (not shown). In some embodiments, AI model 106 may include one or more layers which may correspond to the first portion 202a, the second portion 202b, and the third portion 202c. For example, a first portion of layers of the AI model 106 may correspond to first portion 202a, a second portion of layers of the AI model 106 may correspond to second portion 202b of the AI model 106, and a third portion of layers of the AI model 106 may correspond to third portion 202c of the AI model 106. For instance, the first portion 202a may comprise one or more embedding layers (e.g., to generate embeddings of input data, or other operations), second portion 202b may comprise one or more clustering layers (e.g.,, to assign data to previously generated clusters, to cluster data, to retrieve cluster labels associated with clusters, or other operations), and third portion 202c may include one or more fully connected layers (e.g., configured to generate a prediction or classification, such as identifying an anomaly, predicting an anomaly, or other predictions). In some embodiments, AI model 106 may also include contribution component 203. For example, AI model 106 may include contribution component 203 within AI model 106 itself. For example, contribution component 203 my be integrated within AI model 106 or operate “on top” of AI model 106 or one or more portions of AI model 106 thereof. In other embodiments, however, contribution component 203 may not be part of AI model 106 itself, and may operate as a separate component or model. In some embodiments, contribution component 203 may be associated with one or more portions of AI model 106.

Contribution component 203 may be a component (e.g., model, module, software, framework, etc.) that is configured to determine contribution values of inputs with respect to outputs generated by an AI model. For example, contribution component 203 may be a component that stores and/or executes instructions related to determining SHAP values, Shapley values, integrated gradients, local interpretable model-agnostic explanations, deep learning important features, permutation feature importance, counterfactual explanations, Taylor decompositions, variance-based feature importance, or other AI explainability-related information. For instance, contribution component may be used to determine a contribution value (e.g., a level of importance) of computer network events in relation to an output generated by AI model 106. By doing so, the system may determine which computer network events impacted the output (e.g., the most, the least, etc.) as generated by AI model 106, and then use such computer network events to determine a context associated with the computer network events. In turn, as will be explained later, the system may generate a human-interpretable, generalized, explanation as to why the AI model generated a given input-thereby enhancing the user experience as opposed to simply viewing extremely granular contribution values that do not facilitate high-level understanding of why a given prediction was generated.

Contribution component may receive information from one or more model portions 202a-202c. For example, contribution component 203 may receive output data from first portion 202a (e.g., embeddings of computer network events) and information from third portion 202c, such as outputs (e.g., third output 204c), or other model-related information (e.g., model configurations, weights, biases, or other parameters). Using such information, contribution component 203 may generate, based on a set of computer network events 104 provided as input to AI model 106 (or first portion 202a), an indication of a subset of computer network events that contributed to an identified anomaly (e.g., prediction) generated via AI model 106 (e.g., third portion 202c). For example, contribution component 203 may determine a contribution value associated with each computer network event of the set of computer network events 104. The contribution values associated with each computer network event of the set of computer network events 104 may be used to determine a subset of computer network events 108 of the set of computer network events 104 (e.g., provided as input to the AI model 106). For example, subset of computer network events 108 may be computer network events that the AI model 106 weighed greater than a threshold weight relative to other computer network events in the set of computer network events.

As an example, the system may determine a subset of computer network events 108 (FIG. 1). The system may generate subset of computer network events 108 (e.g., first output 204a (FIG. 2)) based on the computer network events of set of computer network events 104 contributing to the anomaly. AI model 106 may generate subset of computer network events 108 based on the contribution values as determined by contribution component 203. For example, contribution component 203 may compare the contribution values of each computer network event of set of computer network events 104 to a threshold value (e.g., a threshold contribution value, a threshold weight). The threshold value may be received from a user device, a default value stored in the system, AI model 106, contribution component 203, a value stored in a database accessible to the system, or other component. In response to the contribution value associated with a computer network event of set of computer network events 104 satisfying the threshold value, it may be included in subset of computer network events 108. In response to the contribution value or weight associated with a computer network event of set of computer network events 104 failing to satisfy the threshold value, the computer network event may not be included in subset of computer network events 108.

As discussed above, first portion 202a may include an embedding model (or layers corresponding to an embedding layer of AI model 106). For example, AI model 106 may receive a set of computer network events 104 as input. The first portion 202a may generate embeddings of each computer network event of the set of computer network events 104 and may provide such embeddings to second portion 202b and third portion 202c. Each computer network embedding of the set of computer network embeddings may indicate event information of a respective computer network event of set of computer network events 104. For example, first portion 202a may encode the event information of a computer network event using one-hot encoding, label encoding, binary encoding, or another encoding algorithm. For example, a first computer network event of the set of computer network events 104 may include an event identifier of “transaction” and AI model 106 (or first portion 202a) may one-hot encode the event identifier as “000100”, with the “1” indicating the first event is a transaction. By doing so, the system may cluster computer network event embeddings (e.g., via second portion 202b) to determine a context associated with the computer network events, and provide such computer network event embeddings to a third portion 202c to determine an anomaly.

Second portion 202b may include a clustering model (or layers corresponding to a clustering later of AI model 106). For example, second portion 202b may receive, as input, the generated embeddings from first portion 202a. Second portion 202b may be configured to cluster the embeddings from first portion 202a. For example, second portion 202b may assign the embeddings from first portion 202a into a set of previously generated clusters (e.g., generated via second portion 202b). Additionally or alternatively, second portion 202b may generate new clusters based on the generated embeddings from first portion 202a, in accordance with one or more embodiments. Where second portion 202b assigns the embeddings from first portion 202a into previously generated clusters, second portion 202b may determine a hamming distance, Jaccard similarity, cosine similarity, or other similarity value between each embedding (e.g., generated via the first portion 202a) to embeddings that are part of previously generated clusters—thereby enabling embedding assignment to previously-generated clusters. For example, second portion 202b may be previously trained on a corpus of known computer network events. During (or after) the training routine, cluster labels may be assigned to each cluster, where each cluster label indicates a context reflecting shared characteristics or other traits of the data part of the respective cluster. Second portion 202b may assign newly generated embeddings (e.g., from first portion 202a) to previously generated clusters based on a similarity between (i) the newly generated embedding and (ii) the previously generated, clustered, embeddings. Based on a similarity satisfying a threshold similarity (e.g., a predetermined similarity value), second portion 202b may assign the generated embeddings from first portion 202a to one or more clusters generated via second portion 202b. By doing so, as will be explained later, the system may retrieve a context (e.g., the cluster labels) associated with a subset of computer network events that contributed to an identified anomaly, thereby enabling standardized AI-derived prediction explanations to be provided to a user.

Each cluster generated by AI model 106 (e.g., second portion 202b) may be associated with a specific type of event information or a pattern based on the event information. For example, a first cluster may be associated with credit card disputes and a second cluster may be associated with computer network events occurring at irregular times for a user associated with the computer network events. Each cluster of a set of clusters (e.g., generated by AI model 106) may include one or more labels. The labels may indicate context 110 associated with the respective cluster of the set of clusters or sub cluster. The label may be based on the computer network event information associated with computer network event embeddings that are part of the respective cluster. For example, if the cluster includes home goods, the label may be home goods. If the cluster includes transactions over two thousand dollars, the label may be transactions over two thousand dollars. The system or AI model 106 may determine a set of labels based on computer network event information of computer network events that are part of a respective cluster or based on user-provided labels.

Third portion 202c may include a prediction model (e.g., one or more fully connected layers) configured to generate a prediction. For example, third portion 202c may receive input information from first portion 202a, and generate an output (e.g., third output 204c). For instance, third portion 202c may be configured to receive embeddings of computer network events generated via first portion 202a as input, and may generate an anomaly prediction. Third output 204c may indicate whether an anomaly is associated with the set of computer network events 104. In some embodiments, third output 204c may be a binary label where “0” indicated no anomaly, and “1” indicates an anomaly. In other embodiments, however, third output 204c may be a multi-class output, where multiple anomalies (or predictions) may exist. For example, third output 204c may indicate a given anomaly of a plurality of anomalies. For instance, for a given set of computer network events, a first anomaly may be “man-in-the-middle attack,” and a second anomaly may be a “security breach.” In yet other embodiments, third portion 202c may be configured to generate other predictions, anomalies, or other data as third output 204c.

The system may train one or more portions 202 of AI model 106. For example, the system may train first portion 202a of AI model 106 during a training routine. The system may provide first portion 202a with a training dataset. The training dataset may include computer network events. For example, as discussed above, the first portion 202a may be an embedding model. The embedding model may be trained via supervised, unsupervised, or semi-supervised training techniques. For instance, in an unsupervised training routine, the system may provide unlabeled computer network events (e.g., including the computer network event information such as the computer network event identifiers, entity identifiers, values, and timestamps) to the first portion 202a to generate embeddings corresponding to the computer network events. In some embodiments, the system may provide a series of computer network events to the first portion 202a to preserve time-dependent information. In the unsupervised training routine, the first portion 202a may be provided with the unlabeled computer network events to generate an embedding, and then the model may minimize a reconstruction error to adjust the embeddings (e.g., learn an embedding space). In a supervised training routine, first portion 202a may generate an embedding of one or more computer network events, and may adjust the embeddings through backpropagation to minimize a loss when compared to an expected output (e.g., a correct or known embedding). By doing so, the system may train first portion 202a to generate embeddings of computer network events which may then be leveraged by second portion 202b to cluster the generated embeddings.

The system may train second portion 202b of AI model 106 during a training routine. For example, the system may train second portion 202b of AI model 106 during a training routine. The second portion 202b may be trained in conjunction or separately from first portion 202a. During the training routine, the system may receive a hyperparameter value. The hyperparameter value may correspond to a hyperparameter indicating a number of clusters to be generated. For example, a hyperparameter value is set to five may indicate five clusters to be generated. The system may receive the hyperparameter from a user device (e.g., a hyperparameter provided by a user, a predetermined hyperparameter, etc.). Additionally or alternatively, the system may receive the hyperparameter from a database, where the hyperparameter value may be a default value. The database may be included in the system or may be separate and accessible by the system.

The system may provide a training dataset as an input to second portion 202b of AI model 106. Second training dataset may include a set of computer network event embeddings. For example, the set of computer network event embeddings may be the computer network event embeddings generated via first portion 202a of AI model 106. AI model 106 may generate a set of clusters. For example, the system may provide, the set of computer network event embeddings to second portion 202b to generate a set of clusters via second portion 202b. Each cluster in the set of clusters may include subset of embeddings of second set of computer network event embeddings. For example, second portion 202b of AI model 106 may divide the set of computer network events embeddings of the training dataset into a number of clusters corresponding to the hyperparameter value, each of the clusters including a subset of the second set of computer network events. By doing so, each cluster may include a subset of computer network event embeddings that share a common characteristic. Furthermore, by generating an amount of clusters based on the provided hyperparameter value, the system may control an amount of clusters to be generated. In this way, the system may reduce the amount of computational resources expended when generating (or otherwise assigning or determining) cluster labels (e.g., context) to a given cluster.

During the training routine, the system or AI model 106 may determine an embedding metric for each cluster of the set of clusters. The embedding metric may indicate the quality of how well each cluster aligns with the subset of second set of computer network events associated with that cluster or other clusters. The embedding metric may be calculated using a silhouette score, a Davies-Bouldin index, a Dunn index, or another equation to assess the quality of the set of clusters. The system or AI model 106 may compare the embedding metric for each cluster of the set of clusters to a threshold embedding metric. The system may receive the threshold embedding metric from a user device. The system may include the threshold embedding metric or may receive the threshold embedding metric from a database accessible to the system. In response to the embedding metrics for the set of clusters failing to satisfy the threshold embedding metric (e.g., failing to meet or exceed the threshold embedding metric), the system may update one or more hyperparameters of the second portion 202b of AI model 106 to an updated hyperparameter value. In response to the embedding metrics for the set of clusters satisfying the threshold embedding metric, the system may not update one or more hyperparameters of second portion 202b of AI model 106.

Updating the hyperparameter to the updated hyperparameter value may allow second portion 202b to generate a second set of clusters. The second set of clusters the same as or different from the first set of clusters. The system may then determine a second embedding metric for each cluster of the second set of clusters. The system may compare the second embedding metrics for the second set of clusters to the threshold embedding metric and determine that the second embedding metrics for the second set of clusters satisfy the threshold embedding metric. However, if the second embedding metrics fail to satisfy the threshold embedding metric, the system may repeat the training process until the respective embedding metrics satisfy the threshold embedding metric—thereby optimizing cluster quality. In this way, the system ensures that high-quality clusters are being generated, as well as avoiding super-granular cluster-labels from being used to explain an AI-derived prediction. For example, because the amount of clusters being generated directly impacts the amount of explanations (e.g., contexts) that may be provided in a context report, the system balances high-cluster quality with the amount of clusters generated. By doing so, the system mitigates the impact of user-confusion caused by similar, yet different explanations being derived from close-distance cluster's being generated. That is to also enhance user comprehension of why a AI-derived prediction was generated, the system controls the amount of clusters being generated in view of the embedding metrics to avoid (i) super-granular cluster labels stemming from a large amount of clusters being generated and (ii) overly broad cluster labeled stemming from a small amount of clusters being generated—thereby enhancing layperson understanding of why a given prediction was generated.

The system may determine context 110 (FIG. 1) associated with each cluster in the set of clusters. The system may label the respective cluster of the set of clusters with a determined context 110. The system may determine context 110 associated with each cluster in the set of clusters during the training routine of first portion 202a or second portion 202b of AI model 106. Context 110 may be based on a user input received by the system. For example, a user (e.g., a data scientist) may manually assign context 110 to a cluster based on a corresponding set of computer network events 104 associated with computer network event embeddings part of the cluster. As an example, the system may determine a set of clusters generated during a training routine via the second portion 202b of AI model 106. Each cluster may include a set of computer network event embeddings. The system may then receive, for each cluster of the set of clusters, a user input indicating a respective context corresponding to a respective set of computer network embeddings part of a respective cluster. In some embodiments, the system may use a decoder to decode the computer network embeddings part of the respective cluster to provide a human-interpretable version of the computer network events associated with the computer network embeddings part of the respective cluster. In other embodiments, the system may retrieve (e.g., based on a database storing a mapping of computer network event embeddings to computer network events), the computer network events associated with each embedding part of the respective cluster. The user may then analyze the computer network events part of the respective cluster and may provide a user-provided label indicating a category, characteristic, or other context to be associated with the respective cluster based on the computer network events part of that cluster. By doing so, the system enables a human-derived context to be provided to laypersons when understanding why a generated prediction was generated.

In some embodiments, context 110 may be generated automatically. For example, the system may determine a first cluster generated during a training routine by the second portion 202b of AI model 106. The first cluster may include a set of computer network event embeddings. The system may extract, from the first cluster, the set of computer network event embeddings. The system may then determine, based on the set of computer network event embeddings (e.g., part of the first cluster), for each computer network event of the set of computer network events corresponding to the computer network event embeddings, (i) a respective entity identifier associated with a respective computer network event embedding, and (ii) a respective value associated with the respective computer network event embedding. For instance, to obtain the respective entity identifier or respective value, the system may, similar to the above, use a decoder to obtain such values (e.g., regenerating the respective computer network event). In other embodiments, however, the system may use the mapping of embeddings to computer network events, and obtain the respective entity identifier and respective value from the computer network events themselves. For example, in a cybersecurity embodiment, the entity identifier may indicate a given user identifier and the value may indicate an amount of data that was transmitted with respect to the computer network event. In a financial services embodiment, the entity identifier may indicate a merchant identifier and the value may be a transaction amount. The system may then determine, based on the respective entity identifiers and respective values, a context. For example, the system may determine the respective entity identifiers and respective values for each computer network event embedding part of the cluster. Based on all of the entity identifiers and respective values for the computer network event embeddings part of the first cluster, the system may generate a context to label the first cluster with. The system may repeat such process for each cluster generated by second portion 202b. However, it should be noted, that while entity identifiers and values are used in the example above, all available event information associated with the computer network events corresponding to the embeddings part of a respective cluster may be used to generate the context.

In some embodiments, the context (e.g., used to label the clusters) may be generated using a large language model. The system may populate a large language model prompt with an instruction and event information. For example, the instructions may be to generate a domain-specific context (e.g., context 110) based on entity identifiers, values, and other event information. The system may then populate the large language model prompt with the entity identifiers, values, and other event information corresponding to the determined entity identifiers, values, or other computer network event information. The system may provide the populated large language model prompt to the large language model and may receive context 110 from the large language model.

For example, the large language model may be trained to generate context 110 based on populated large language model prompt. For instance, upon providing the large language model prompt as input to the large language model, the system may receive, from the large language model, the domain-specific context indicating the respective context for clusters generated via second portion 202b. For instance, with respect to the example above, the system may populate a separate large language model prompts with entity identifiers and values from a respective cluster that second portion 202b generated. For example, where the computer network events part of a first cluster indicate “Entity Identifiers: [Card1234, Card 5678, Card9101]. Values: [500, 1200, 300],” the system may populate a prompt to recite “Instructions: Generate a domain-specific context based on the following credit card transaction data. Entity Identifiers: [Target, Apple, Microsoft]. Values: [500, 1200, 300].” The system may then provide the populated prompt to the LLM and receive a response. For example, the response may indicate a domain-specific context to be used as a label for the first cluster reciting “high-value purchases at technology stores.” By doing so, the system may avoid conflating information from multiple clusters, and instead, provide a focused approach keyed to each cluster to receive LLM-derived contexts to label the clusters with. The system may repeat such steps using the LLM-derived contexts until each cluster generated via second portion 202b has been labeled. In some embodiments, the large language model may be separate from, but accessible by the system. The large language model may be included in the system. For example, the large language model may be included in AI model 106.

The system may train third portion 202c of AI model 106 during a training routine. For example, the system may train third portion 202c of AI model 106 during a training routine. The third portion 202 c may be trained in conjunction or separately from first portion 202a, second portion 202b, or other portions. During the training routing, the system may provide third portion 202c a training dataset as input. For example, the system may provide a first portion of training data including a set of computer network embeddings. In some embodiments, the set of computer network embeddings may be the same or similar to those generated via first portion 202a. However, in some embodiments, the set of computer network event embeddings may be different or separate from those generated via first portion 202a. In some embodiments, the set of computer network event embeddings may be unlabeled to facilitate unsupervised machine learning training. To facilitate supervised machine learning model training, however, the set of computer network event embeddings may be labeled with one or more labels. For example, the labels may indicate (i) a computer network event identifier, (ii) a known anomaly identifier (e.g., identifying an anomaly associated with the set of computer network embeddings, an anomaly associated with the computer network event associated with the computer network event embedding, etc.), (iii) a value associated with a respective computer network event embedding (e.g., an amount of data transmitted, a transaction amount, a refund amount, or other value in accordance with one or more embodiments), and (iv) a timestamp associated with the respective computer network event embedding.

The system may provide the first portion of the training data as input to the third portion 202c of AI model 106 model to generate, via the AI model 106, an output. For example, the output may indicate a predicted anomaly associated with the set of computer network event embeddings (e.g., of the first portion of the training data). The system may then update one or more configurations of the third portion 202c of AI model 106 based on a comparison between (i) the predicted anomaly and (ii) the known anomaly (e.g., from the label part of the first portion of the training data). For example, the system may update the configurations (e.g., parameters, weights, biases, etc.) of the third portion 202c of the AI model 106 by comparing the predicted anomaly to the known anomaly. For instance, the system may determine an error between the predicted anomaly and the known anomaly using one or more loss functions (e.g., mean absolute error, mean squared error, root mean squared error, etc.). In response to the error satisfying the threshold value (e.g., meeting or exceeding the threshold value), the system may not update the one or more parameters. In response to the error failing to satisfy the threshold value, the system may update the one or more parameters. By doing so, the system may train AI model 106 to identify one or more anomalies associated with the set of computer network events.

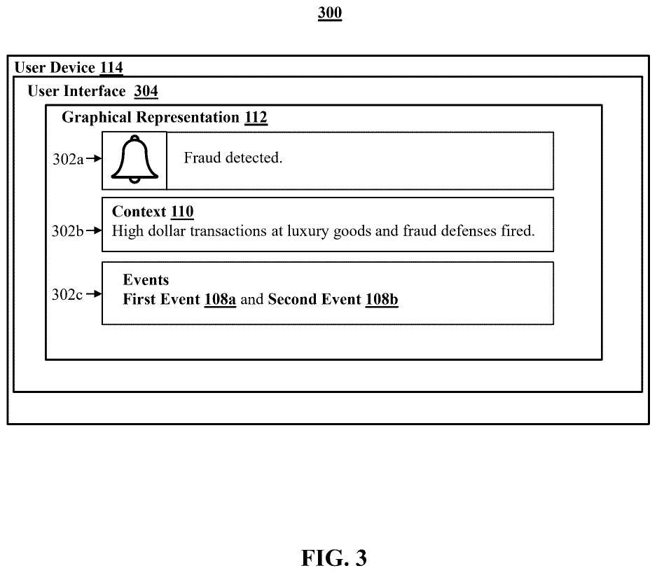

FIG. 3 shows an illustrative diagram 300 of a graphical representation 112 generated based on outputs 204a-204c of AI model 106. The system may generate a graphical representation 112 to be displayed to a user. Graphical representation 112 may a context report associated with one or more outputs 204 of AI model 106. For example, graphical representation 112 may be a context report indicating an identified anomaly, computer network events contributing to the anomaly, and a context associated with the computer network events contributing to the anomaly. Graphical representation 112 may include one or more graphical elements, such as images, text boxes, graphs, info graphics, icons, tables, videos, or other various multimedia content.

Graphical representation 112 may include one or more regions 302a-302c (e.g., first region 302a, second region 302b, third region 302c, etc.). Each region of regions 302a-302c (e.g., portions of the graphical representation) may be associated with one or more outputs 204a-204c. The system may generate a first region 302a, a second region 302b, and third region 302c of graphical representation 112. First region 302a of graphical representation 112 may be associated with third output 204c, second region 302b of graphical representation 112 may be associated with second output 204b, and third region 302c may be associated with first output 204a.

The system may generate first region 302a to indicate an anomaly, second region 302b to indicate context 110 associated with a subset of computer network events contributing to the anomaly, and third region 302c may indicate subset of computer network events contributing to the anomaly. The third region 302c may be generated based on the first region 302a and the second region 302b. For example, to provide a human-interpretable context report that laypersons may understand to provide an explanation of why a given prediction (e.g., anomaly, output, etc.) has been generated, the system may generate graphical representation 112 to display, to a user, (i) an identified anomaly, (ii) a context as to why the anomaly was generated based on a subset of computer network events that contributed to the identified anomaly, or (iii) an indication of the subset of computer network events that contributed to the identified anomaly.

In a financial services embodiment, the system may generate graphical representation 112 in response to identifying an anomaly associated with a set of computer network events. For example, the system may identify an anomaly (e.g., fraud detected) associated with a set of financial transactions of a user's account. However, while knowing which detected/predicted anomaly is useful to the user (e.g., in order to cancel one or more cards, update security settings of the user's financial account, etc.), the user may be at a loss as to understanding “why” the given anomaly has been identified. While existing systems may use SHAP values or other AI explainability methods to determine respective weights associated with features of input data indicating “how much” such features contributed to an anomaly, such weights merely indicate a “level of importance” of such input features—leaving interpretation up to the user as to “why” a given prediction was generated by an AI model. In other words, although these weights may indicate which input features the AI model weighed higher than other features, these values are directly keyed to the individual input features themselves as opposed to a broader, higher-level concept share among top weighted features that may facilitate human understanding of a reason why a given prediction was generated. To overcome this, the system may instead, use a determined context associated with “top” input features of the input data to supplement user understanding of why a given anomaly has occurred. To do so, as explained above, the system may determine a context (e.g., a cluster label) associated with a subset of computer network events contributing to an identified/determined anomaly—thereby enhancing the user experience by providing a high-level, human understandable, reason as to why a given anomaly was identified/determined.

Continuing with the example above, the system may identify an anomaly associated with a set of transactions associated with the user's account. For example, there may exist 100 financial transactions that were provided as input to AI model 106 to determine whether an anomaly is associated with the user's financial account activity. The system may determine (e.g., via AI model 106) that fraud was detected. To provide the user with an interpretable report indicating why fraud was detected, the system may generate graphical representation 112 (e.g., a context report). The context report may include the identified anomaly, a context as to why the anomaly was identified, and specific events that contributed to the anomaly being identified/determined. For example, graphical representation 112 may include first region 302a indicating the identified anomaly (e.g., fraud detected), a second region 302b indicating the context as to why the anomaly was identified (e.g., high dollar transactions at luxury goods and fraud defenses fired), and third region 302c indicating a subset of computer network events (e.g., a set of transactions) that contributed to the identified anomaly. For example, context 110 may be included in second region 302b based on a subset of transactions that contributed to the anomaly being detected. For instance, as explained above, the system may determine that a first event 108a (e.g., a first transaction) and a second event 108b (e.g., a second transaction) of a set of computer network events 104 (e.g., the set of transactions provided as input to the AI model) are associated with a contribution value that satisfies a contribution threshold value (e.g., indicating that such transactions contributed the most to, or are deemed to have triggered the prediction to be generated). For example, first event 108a and second event 108b may be part of a determined subset of computer network events 108, in accordance with one or more embodiments. The system may then determine a cluster label (e.g., indicating a context) associated with each of first event 108a and second event 108b. In some embodiments, the context 110 may include a cluster label associated with both first event 108a and second event 108b (e.g., where the cluster labels associated with first event 108a and second event 108b are the same), or separate cluster labels associated with the first event 108a and second event 108b (e.g., where the cluster labels associated with first event 108a and second event 108b are different). In other words, second region 302b may include one or more identified context's 110 based on a subset of computer network events 108 that are determined to have a contribution value satisfying the threshold contribution value. The system may also generate third region 302c to include an indication of the subset of computer network events 108 (e.g., a subset of transactions) that contributed to the anomaly being identified/determined to enable a user to see which events caused the anomaly to be identified/determined. By doing so, the system may enhance user understanding as to why a given prediction was generated by AI model 106.

FIG. 4 shows illustrative components for a system used to generate a human-interpretable context report associated with anomalous computer network event logs of users in accordance with one or more embodiments. As shown in FIG. 4, system 400 may include mobile device 422 and user terminal 424. While shown as a smartphone and personal computer, respectively, in FIG. 4, it should be noted that mobile device 422 and user terminal 424 may be any computing device, including, but not limited to, a laptop computer, a tablet computer, a hand-held computer, and other computer equipment (e.g., a server), including “smart,” wireless, wearable, and/or mobile devices. FIG. 4 also includes cloud components 410. Cloud components 410 may alternatively be any computing device as described above, and may include any type of mobile terminal, fixed terminal, or other device. For example, cloud components 410 may be implemented as a cloud computing system, and may feature one or more component devices. It should also be noted that system 400 is not limited to three devices. Users may, for instance, utilize one or more devices to interact with one another, one or more servers, or other components of system 400. It should be noted, that, while one or more operations are described herein as being performed by particular components of system 400, these operations may, in some embodiments, be performed by other components of system 400. As an example, while one or more operations are described herein as being performed by components of mobile device 422, these operations may, in some embodiments, be performed by components of cloud components 410. In some embodiments, the various computers and systems described herein may include one or more computing devices that are programmed to perform the described functions. Additionally, or alternatively, multiple users may interact with system 400 and/or one or more components of system 400. For example, in one embodiment, a first user and a second user may interact with system 400 using two different components.

With respect to the components of mobile device 422, user terminal 424, and cloud components 410, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 4, both mobile device 422 and user terminal 424 include a display upon which to display data (e.g., conversational response, queries, and/or notifications).

Additionally, as mobile device 422 and user terminal 424 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 400 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 4 also includes communication paths 428, 430, and 432. Communication paths 428, 430, and 432 may include the Internet, a mobile phone network, a mobile voice or data network (e.g., a 5G or LTE network), a cable network, a public switched telephone network, or other types of communications networks or combinations of communications networks. Communication paths 428, 430, and 432 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 410 may include AI model 106 of FIG. 1. Cloud components 410 may access (e.g., communicate with) one or more user devices (e.g., user device 114) and one or more databases. For example, cloud components 410 may host one or more databases such as a system data database (e.g., storing computer network events, computer network event information, computer network activity logs, financial account activity data, user data, transaction logs, etc.), model data database (e.g., storing one or more pre-trained artificial intelligence models, training data for the artificial intelligence models, model configuration profiles (e.g., weights, biases, or other parameters), etc.), or other databases used to facilitate one or more operations of the present disclosure, in accordance with one or more embodiments.

Cloud components 410 may include model 402 (e.g., AI model 106), which may be a machine learning model, artificial intelligence model, etc. (which may be referred collectively as “models” herein). Model 402 may take inputs 404 and provide outputs 406. The inputs may include multiple datasets, such as a training dataset and a test dataset. Each of the plurality of datasets (e.g., inputs 404) may include data subsets related to user data, predicted forecasts and/or errors, and/or actual forecasts and/or errors. In some embodiments, outputs 406 may be fed back to model 402 as input to train model 402 (e.g., alone or in conjunction with user indications of the accuracy of outputs 406, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., outputs 204, etc.).

In a variety of embodiments, model 402 may update its configurations (e.g., weights, biases, or other parameters) based on the assessment of its prediction (e.g., outputs 406) and reference feedback information (e.g., user indication of accuracy, reference labels, or other information). In a variety of embodiments, where model 402 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 402 may be trained to generate better predictions.

In some embodiments, model 402 may include an artificial neural network. In such embodiments, model 402 may include an input layer and one or more hidden layers. Each neural unit of model 402 may be connected with many other neural units of model 402. Such connections may be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 402 may be self-learning and trained, rather than explicitly programmed, and may perform significantly better in certain areas of problem solving, as compared to traditional computer programs. During training, an output layer of model 402 may correspond to a classification of model 402, and an input known to correspond to that classification may be input into an input layer of model 402 during training. During testing, an input without a known classification may be input into the input layer, and a determined classification may be output.

In some embodiments, model 402 may include multiple layers (e.g., where a signal path traverses from front layers to back layers). In some embodiments, back propagation techniques may be utilized by model 402 where forward stimulation is used to reset weights on the “front” neural units. In some embodiments, stimulation and inhibition for model 402 may be more free-flowing, with connections interacting in a more chaotic and complex fashion. During testing, an output layer of model 402 may indicate whether or not a given input corresponds to a classification of model 402 (e.g., anomalous credit card usage, etc.).

In some embodiments, the model (e.g., model 402) may automatically perform actions based on outputs 406. In some embodiments, the model (e.g., model 402) may not perform any actions. The output of the model (e.g., model 402) may be used to generate a human-interpretable context report (e.g., graphical representation 112) associated with an identified anomaly.

System 400 also includes API layer 450. API layer 450 may allow the system to generate summaries across different devices. In some embodiments, API layer 450 may be implemented on mobile device 422 or user terminal 424. Alternatively or additionally, API layer 450 may reside on one or more of cloud components 410. API layer 450 (which may be A REST or Web services API layer) may provide a decoupled interface to data and/or functionality of one or more applications. API layer 450 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 450 may use various architectural arrangements. For example, system 400 may be partially based on API layer 450, such that there is strong adoption of SOAP and RESTful Web-services, using resources like Service Repository and Developer Portal, but with low governance, standardization, and separation of concerns. Alternatively, system 400 may be fully based on API layer 450, such that separation of concerns between layers like API layer 450, services, and applications are in place.

In some embodiments, the system architecture may use a microservice approach. Such systems may use two types of layers: Front-End Layer and Back-End Layer where microservices reside. In this kind of architecture, the role of the API layer 450 may provide integration between Front-End and Back-End. In such cases, API layer 450 may use RESTful APIs (exposition to front-end or even communication between microservices). API layer 450 may use AMQP (e.g., Kafka, RabbitMQ, etc.). API layer 450 may use incipient usage of new communications protocols such as gRPC, Thrift, etc.

In some embodiments, the system architecture may use an open API approach. In such cases, API layer 450 may use commercial or open source API Platforms and their modules. API layer 450 may use a developer portal. API layer 450 may use strong security constraints applying WAF and DDoS protection, and API layer 450 may use RESTful APIs as standard for external integration.

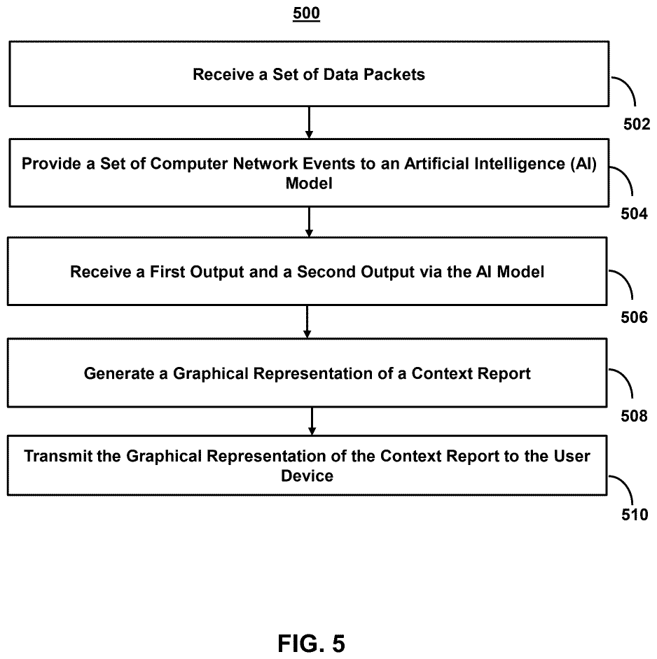

FIG. 5 shows a flowchart of the steps involved in generating a human-interpretable context report associated with an anomaly, in accordance with one or more embodiments. For example, the system may use process 500 (e.g., as implemented on one or more system components described above) in order to generate a context report associated with unauthorized access to a computer network.

At step 502, process 500 (e.g., using one or more components of system 400 described above) may receive a set of data packets (e.g., set of data packets 102). For example, the system may receive the set of data packets over a first computer network. The set of data packets may include a set of computer network events (e.g., computer network events 104) associated with a first user. For example, the set of data packets may be an encrypted representation of the computer network events to help protect sensitive user data transmitted over the computer network. The set of computer network events may be computer network event log entries associated with a first user terminal of a first user. In a cybersecurity embodiment, the system may receive real-time streamed computer network event log entries indicating actions or other events a computer, user, or other device associated with a computing network enacts. The system may actively monitor for one or more anomalies that may be indicative of a cybersecurity attack on the computer network. However, while detecting anomalies associated with a computing system may be useful as users may be able to react to a cybersecurity attack (or at least become aware of such), to facilitate high-level understanding as to why a cybersecurity attack (or other anomaly) was detected, as will be explained, the system may determine a context associated with one or more computer network events contributing to the identified anomaly to enhance user understanding.

As another example, in a financial services embodiment, the set of data packets may include a set of computer network events associated with financial account activity of a first user. For example, the set of computer network events may include transactions, disputes, payments, refund, authorization, balance transfer, credit limit changes, or other credit card usage events. Similar to the above, the system may receive streamed (e.g., real-time) financial account activity from one or more users to detect an anomaly associated with user's financial account activity. In particular, however, if an anomaly is identified (e.g., fraud, irregular purchases, etc.) end-users (e.g., customers) are often at a loss in understanding why an anomaly was identified. In instances where financial accounts may be locked upon identification of an anomaly, user understanding of what events, and why those events triggered an anomaly to be identified is imperative. For example, while existing systems may point out some specific events related to the anomaly, such systems fail to provide a high-level context associated with the events that contributed to the anomaly. Without such context, end-users may be left unaware as to the “why” and may continue to proceed with their usual activity which may lead to a reoccurring anomaly being identified (e.g., due to lack of understanding), and subsequent account lockouts—thereby causing an increase in network traffic and utilization of computational resources that could otherwise be used for other tasks. To overcome this, the system may determine a context associated with events related to the anomaly to enhance user-understanding of why a given anomaly (or other prediction) was generated.

At step 504, process 500 (e.g., using one or more components described above) may provide a set of computer network events to an AI model (e.g., AI model 106). For example, the system may provide the set of computer network events as input to an AI model to generate, based on the set of computer network events, via the AI model, outputs (e.g., outputs 204a-204c, first output 204a, second output 204b, third output 204c, etc.). The system may generate, via the AI model, a first output identifying a subset of computer network events (e.g., subset of computer network events 108) contributing to an identified anomaly associated with the set of computer network events and a second output indicating a context (e.g., context 110) associated with the subset of computer network events. In some embodiments, the system may generate an output indicating a computer network log anomaly associated with the computer network events, an output identifying a subset of computer network event log entries, and an output indicating a cluster-derived description associated with the subset of computer network event log entries.

For example, when generating a prediction via the AI model (e.g., determining whether an anomaly is associated with the set of computer network events, an anomaly of the set of computer network events, etc.), the AI model may have weighted the subset of computer network log entries greater than a threshold weight relative to other computer network event log entries to determine the first output. For example, the system may determine a contribution value of each computer network event of the set of computer network events. When a contribution value satisfies (e.g., meets or exceeds) a threshold contribution value, the system may identify a subset of computer network events that contributed to the anomaly. For example, the subset of computer network events may reflect computer network events that are most important with respect to the anomaly (or regarded as those which triggered the anomaly to be identified). The outputs may be generated by different portions (e.g., first portion 202a, second portion 202b, third portion 202c) of the AI model.

For example, in a cybersecurity embodiment, the system may provide the set of computer network events as input to an AI model trained to identify anomalous user behavior. For example, a user may have a behavior of logging into the network every day at roughly 8:00 AM while computer network events 104 may indicate the user attempting and failing to log into the network four additional times in one day between 1:30 AM and 2:30 AM. For instance, the computer network events 104 may include five events including: a first event including a first successful login attempt on April 18th at 8:00 AM, a second event including a second successful login attempt on April 19th at 8:01 AM, a third event including a third successful login attempt on April 20th at 7:58 AM, a fourth event including a first failed login attempt on April 20th at 1:34 AM, and a fifth event including a second failed login attempt on April 20th at 1:38 AM. The system may provide the set of computer network events to the AI model and the AI model may generate an output indicating “unexpected log in” (e.g., an anomaly). Upon generating the prediction, within a threshold time period, the system may determine contribution values associated with each event of the set of computer network events. For example, the first event may be determined to have a contribution value of 0.2, the second event may be determined to have a contribution value of 0.4, the third event may be determined to have a contribution value of 0.1, the fourth event may be determined to have a contribution value of 0.8, and the fifth event may be determined to have a contribution value of 0.9.

The system may determine a subset of computer network events as contributing to the anomaly when a respective event satisfies a contribution threshold. For example, the contribution threshold may be set to 0.75. As such, the system may determine a subset of computer network events to include the fourth and fifth event (e.g., as contributing to the identified anomaly). However, while presenting such events to the user may be helpful, they still may lack contextual information as to why the anomaly was identified. As such, the system may determine a context, via the AI model to enhance user understanding. For example, the system may determine clusters associated with the computer network events of the subset of computer network events to determine a context.

As described above, to determine a context of “why” an AI model generated a prediction (e.g., indication of an anomaly), the system may determine one or more clusters that the subset of computer network events contributing to the prediction are part of. For instance, the system may determine that the fourth event and the fifth event are part of a cluster associated with a label “Failed login attempts at unusual times.” As such, the system may use the cluster label to provide context to the user as to why the AI model generated the given prediction. For example, the system may generate a graphical representation that includes the identified anomaly, the subset of events contributing to the anomaly, and the context determined based on the subset of events contributing to the anomaly. The system generating the various outputs via the AI model enables understanding of how the AI model identified the anomaly and what computer network events of the set of computer network events contributed to the identification of the anomaly. By the system generating the cluster-derived context descriptions, the system may provide a human-interpretable description of how the anomaly was identified while saving on computational resources (e.g., power consumption, memory storage, processing time, etc.) that would otherwise be wasted during additional processing techniques to determine an underlying theme or reason.

In a financial services embodiment, the set of computer network events may be a set of transactions associated with a user's financial account. For example, the set of computer network events may include a first transaction indicating a grocery store purchase for $20, a second transaction at a technology store for $2,000, and a third transaction indicating a supermarket purchase for $100. The system may provide the set of computer network events to the AI model and the AI model may generate a prediction indicating an anomaly of “unusual account activity.” For example, the AI model may be trained using financial account activity of the user and may determine (e.g., based on the technology store transaction), that unusual account activity has been identified. Similar to the above example, the system may identify a subset of events that contributed to the identified anomaly. For example, the system may determine that the second transaction at the technology store had a contribution value satisfying a threshold contribution value. To enhance customer understanding, the system may determine a cluster that the second transaction belongs to, and may use the cluster label to determine a context as to why the prediction was generate. For example, the second transaction may be part of a cluster indicating “large purchase at luxury good store.” As such, the system may use the determined cluster label to generate a graphical representation indicating supplemental information as to why the AI model generated the prediction.

In some embodiments, the subset of computer network events may include one or more computer network events of the set of computer network events that the AI model weighted greater than a threshold weight relative to other computer network events in the set of computer network events. For example, the system may assign a weight to each computer network event of the set of computer network events based on how much each computer network event contributed to the identified anomaly. The system may then compare the weight of each computer network event of the set of computer network events with the threshold weight. In response to a computer network event of the set of computer network events satisfying the threshold weight, the system may include the computer network event in the subset of computer network events. For example, the system may identify the anomaly to be an unusual transaction amount made by a credit card user. The system may then weight computer network events including unusual transaction amounts for the user higher than computer network events including transaction amounts expected for the user. This may enable the system to save on computational resources by enabling the system to generate the outputs based on a subset of all the computer network events received instead of generating the outputs based on all the computer network events.

In some embodiments, the system may determine contribution values of computer network events to generate a first output identifying a subset of computer network events in connection with generating a third output indicating an anomaly associated with the set of computer network events. For example, the system may determine a contribution value associated with each computer network event of the set of computer network events. The contribution value may be determined at the same time, within a threshold time, before, or after the anomaly has been identified. The system may determine the subset of computer network events contributing to the identified anomaly based on the contribution value of respective computer network events of the set of computer network events satisfying a threshold contribution value. For example, where a respective computer network event has a contribution value that meets or exceeds the threshold contribution value, the system may identify the respective computer network event as part of the subset of computer network events contributing to the anomaly. The system may generate the first output based on the subset of computer network events contributing to the anomaly. As an example, the system may determine the anomaly to be credit card usage in an unusual geographic location for a user. The user may live in Canada, and the set of computer network events may include transactions occurring in Canada and France. The system may then include the events occurring in the unusual geographic location for the user (e.g., France) in the subset of computer network events. By doing so, the system may identify individual events that contributed to a given anomaly or other prediction being generated by the AI model—thereby enabling the system to determine an overall reason as to why the prediction was generated by leveraging cluster labels associated with such events.

In some embodiments, the system may generate the second output indicating the context associated with the subset of computer network events based on a set of labels. For example, the system may determine, for each computer network event of the subset of computer network events, a set of embeddings. For example, when the system provides the set of computer network events to the AI model (e.g., to generate a prediction, detect an anomaly, etc.), the AI model may embed the set of computer network events to reduce the dimensionality of the raw data. The embeddings may then be assigned to one or more pre-generated clusters to determine categories that each computer network event corresponds to (e.g., to then be used in generating the context associated with the subset of computer network events). By embedding the set of computer network events (and their associated event information) the system reduces the dimensionality of the computer network events to conserve computer memory resources. By doing so, the system further enables the AI model to determine an anomaly as by using the dimensionally-reduced embeddings as opposed to the raw computer network event data.

The system may then identify, based on the set of embeddings, a set of clusters associated with the set of embeddings. For example, the system may determine the clusters to which each computer network event embedding of the subset of computer network events belong. The system may then determine a set of labels based on the set of clusters. The set of labels may indicate a first context associated with a respective cluster of the set of clusters. The system may then generate the second output indicating the context associated with the subset of computer network events based on the set of labels. For example, the system may determine a numeric embedding for each computer network event of the subset of computer network events. The system may identify a set of clusters based on event information associated with each embedding, for example, an embedding with event information indicating that it is a transaction may be associated with a cluster of the set of clusters associated with transactions. A label of the set of labels associated with the set of clusters may then indicate that the clusters are associated with transactions, and the system may generate the second output based on the label. By doing so, the system may enhance providing additional information (e.g., the set of labels) to the user that may not be discernible directly from the set of computer network events.

In some embodiments, the system may generate the second output based on a subset of clusters associated with the subset of computer network events. For example, the first portion of the AI model may include an embedding layer and the second portion of the AI model may include a clustering layer. The system may then generate a set of computer network event embeddings based on the set of computer network events via the embedding layer of the first portion of the AI model. The system may then provide the set of computer network event embeddings to the clustering layer of the second portion of the AI model. The clustering layer may then assign each computer network event embedding of the set of computer network event embeddings to respective clusters. The clusters may be generated by the clustering layer during a training routine. In connection with generating the first output, the system may determine a subset of clusters associated with the subset of computer network events. The system may then generate the second output based on the determined subset of clusters associated with the subset of computer network events. For example, the system may determine that a first computer network event of the subset of computer network events (or embeddings corresponding to such events) are part of a first cluster, and a second computer network event of the subset of computer network events is part of a second cluster. The first cluster may be associated with <$200 purchases retail stores, and the second cluster may be associated with <$500 purchases at grocery stores. The system may then generate the second output (e.g., indicating the cluster labels associated with the subset of computer network events) based on the subset of clusters. For instance, the system may generate the second output indicating “<$200 purchases retail stores” and “<$500 purchases at grocery stores.” By doing so, the system may provide multiple contexts as to why a given prediction was generated, thereby enhancing the user experience.

In some embodiments, the system may determine a label based on the subset of clusters. For example, the system may determine a label indicating a first context of embeddings part of a respective cluster of the subset of clusters and the system may generate the second output based on the first context. For example, as opposed to determining multiple contexts, the system may determine a single context. For instance, where each computer network event (or corresponding embedding) of the subset of computer network events that contributed to the anomaly are part of the same cluster, the system may obtain the label of the respective to generate the second output.

In some embodiments, the system may generate the second output based on a second context and a third context. For example, the system may determine a set of labels based on the subset of clusters. Each label of the set of labels may indicate a first context of embeddings part of a respective cluster of the subset of clusters. The system may then determine, based on the set of labels, a second context and a third context associated with the subset of clusters and generate the second output based on the second context and the third context. For example, the first context may be, “high value purchases”, the system may determine a second context to be “unusual spending patterns” and a third context to be “potentially fraudulent activity.” Generating the second output based on the second context and third context may further enhance the interpretability and accuracy of the second output. In some embodiments, the system may provide the first, second, and third context to a LLM to generate a summarized version of the first second and third context. For instance, to avoid user-confusion, the system may generate a single context based on the determined first, second, and third contexts to be provided to the user.

At step 506, process 500 (e.g., using one or more components described above) may receive a first output and a second output from the AI model. For example, the system may receive, from the AI model, the first output identifying the subset of computer network events contributing to an identified anomaly within a threshold time period of the second output indicating the context associated with the subset of computer network events. Where the AI model is configured to additionally generate a third output (e.g., indicating the anomaly itself), the system may receive the first output, the second output, and the third output within a threshold time period. For example, the first output, the second output, and the third output may be received within one second of each other. For instance, as opposed to existing systems that perform existing AI-explainability procedures under specific circumstances or during model training routines, the system incorporates such context-determination into the real-time system during an inference operating mode where the outputs are received within the threshold time period-allowing each prediction made by the AI model to be supplemented with additional, domain-specific context to enhance user understanding.

At step 508, process 500 (e.g., using one or more components described above) may generate a graphical representation (e.g., graphical representation 112) of a context report. For example, the system may generate a graphical representation of a context report associated with the identified anomaly, based on the outputs obtained via the AI model. For example, the system may generate the graphical representation based on the first output, the second output, and the third output. The graphical representation of the context report may be generated for display on a user interface (e.g., user interface 304) of a user device or user terminal. The system may save on computational resources by generating the graphical representation of the context report based on the previously generated cluster-derived context descriptions instead of generating the context report from scratch.

At step 510, process 500 (e.g., using one or more components described above) may transmit the graphical representation of the context report to a user device (e.g., user device 114, mobile device 422, user terminal 424). For example, the system may transmit the graphical representation over the first computer network to the user device or user terminal. This may enable the user to transmit feedback on the outputs of the AI model to improve the efficiency and accuracy of the AI model in generating the outputs. In some embodiments, the system may generate one or more portions (e.g., regions 302a-302c) of the graphical representation. For example, the system may generate a first portion of the graphical representation indicating the identified anomaly. The system may generate a second potion of the graphical representation indicating the context associated with the subset of computer network events contributing to the identified anomaly. The system may generate the graphical representation of the context report. This may enable the system to display a human-interpretable context report to the user regarding a reason why the AI model generated a given prediction.

It is contemplated that the steps or descriptions of FIG. 5 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 5.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method, the method comprising: receiving a set of data packets, over a first computer network, comprising a set of computer network events associated with a first user; providing the set of computer network events as input to an artificial intelligence (AI) model to generate, via the AI model, based on the set of computer network events, (i) a first output identifying a subset of computer network events contributing to an identified anomaly associated with the set of computer network events and (ii) a second output indicating a context associated with the subset of computer network events, the first output being generated via a first portion of the AI model, the second output being generated via a second portion of the AI model that is different from the first portion of the AI model; receiving, from the AI model, the first output within a threshold time period of the second output; generating, for display on a user interface of a user device, a graphical representation of a context report associated with the identified anomaly based on the first output and the second output; and transmitting, over the first computer network, the graphical representation the context report to the user device.
2. The method of any one of the preceding embodiments, further comprising: training a third portion of the AI model during a training routine, the training routine comprising: providing a first portion of a training dataset as input to the third portion of the AI model, the first portion of training data comprising a second set of computer network event embeddings, wherein each second computer network event embedding of the second set of computer network event embeddings comprises labels indicating (i) a computer network event identifier, (ii) a known anomaly, (iii) a value associated with a respective computer network event embedding, and (iv) a timestamp associated with the respective second computer network event embedding; generating, based on providing the first portion training data as input to the third portion of the AI model, via the AI model, a third output indicating (i) a third anomaly associated with the second set of computer network event embeddings; and updating one or more parameters of the third portion the AI model based on comparing the third anomaly associated with the second set of computer network event embeddings to the known anomaly.
3. The method of any one of the preceding embodiments, further comprising: training the second portion of the AI model during a training routine, the training routine comprising: receiving, for the second portion of the AI model, a hyperparameter value corresponding to a hyperparameter indicating a number of clusters to be generated; providing a training dataset comprising a second set of computer network embeddings as input to the second portion of the AI model; generating, based on providing the training dataset as input to the second portion of the AI model, via the second portion of the AI model, a set of clusters, wherein each cluster of the set of clusters includes a subset of embeddings of the second set of computer network embeddings; determining an embedding metric for each cluster of the set of clusters; and in response to the embedding metrics for the set of clusters failing to satisfy a threshold embedding metric, updating the hyperparameter of the second portion of the AI model to an updated hyperparameter value, such that the second portion of the AI model generates a second set of clusters, wherein second embedding metrics for the second set of clusters satisfy the threshold embedding metric.
4. The method of any one of the preceding embodiments, wherein the subset of computer network events includes one or more computer network events of the set of computer network events that the AI model weighed greater than a threshold weight relative to other computer network events in the set of computer network events.
5. The method of any one of the preceding embodiments, further comprising: determining a set of clusters generated during a training routine by the second portion of the AI model, wherein each cluster of the set of clusters comprises a second set of computer network event embeddings; receiving, for each cluster of the set of clusters, a user input indicating a respective context corresponding to a respective set of computer network embeddings part of a respective cluster; and labeling each cluster of the set of clusters with the respective context.
6. The method of any one of the preceding embodiments, further comprising: determining a first cluster generated during a training routine by the second portion of the AI model, the first cluster comprising a second set of computer network event embeddings; extracting, from the first cluster, the second set of computer network event embeddings; determining a second set of computer network events corresponding to the second set of computer network event embeddings; determining, based on the second set of computer network events, for each computer network event of the second set of computer network events, (i) a respective entity identifier associated with a respective computer network event of the second set of computer network events and (ii) a respective value associated with the respective computer network event; determining, based on the respective entity identifiers and respective values, a respective context for the first cluster; and labeling the first cluster with the respective context.
7. The method of any one of the preceding embodiments, wherein determining the respective context for the first cluster further comprises: populating a large language model prompt comprising an instruction to generate a domain-specific context based on entity identifiers and values and the respective entity identifiers and values; providing the large language model prompt as input to the large language model; and receiving, from the large language model, the domain-specific context indicating the respective context for the first cluster.
8. The method of any one of the preceding embodiments, wherein generating the first output identifying the subset of computer network events further comprises: generating, based on the set of computer network events, via a third portion of the AI model, a third output indicating the anomaly associated with the set of computer network events; in connection with generating the third output, determining, via the first portion of the AI model a contribution value associated with each computer network event of the set of computer network events; determining the subset of computer network events contributing to the identified anomaly based on the contribution value of respective computer network events of the set of computer network events satisfying a threshold contribution value; and generating the first output based on the subset of computer network events contributing to the anomaly.
9. The method of any one of the preceding embodiments, wherein generating the second output indicating the context associated with the subset of computer network events further comprises: determining, for each computer network event of the subset of computer network events, a set of embeddings, wherein each embedding of the set of embeddings correspond to a respective computer network event of the subset of computer network events; identifying, based on the set of embeddings, a set of clusters associated with the set of embeddings; determining, based on the set of clusters, a set of labels, wherein each label of the set of labels indicate a first context associated with a respective cluster of the set of clusters; and generating, based on the set of labels, the second output indicating the context associated with the subset of computer network events.
10. The method of any one of the preceding embodiments, wherein the first portion of the AI model comprises an embedding layer and the second portion of the AI model comprises a clustering layer, the method further comprising: generating, based on the set of computer network events, via the embedding layer of the first portion of the AI model, a set of computer network event embeddings; providing the set of computer network event embeddings to the clustering layer of the second portion of the AI model to assign each computer network event embedding of the set of computer network events embeddings to respective clusters generated via the clustering layer during a training routine; in connection with generating the first output, determining a subset of clusters associated with the subset of computer network events; and generating the second output based on the determined subset of clusters associated with the subset of computer network events.
11. The method of any one of the preceding embodiments, wherein generating the second output further comprises: determining, based on the subset of clusters, a label indicating a first context of embeddings part of a respective cluster of the subset of clusters; and generating the second output based on the first context.
12. The method of any one of the preceding embodiments, wherein generating the second output further comprises: determining, based on the subset of clusters, a set of labels, wherein each label of the set of labels indicate a first context of embeddings part of a respective cluster of the subset of clusters; determining, based on the set of labels, a second context and a third context associated with the subset of clusters; and generating the second output based on the second context and the third context.
13. The method of any one of the preceding embodiments wherein generating the graphical representation of the context report further comprises: generating a first portion of the graphical representation indicating the identified anomaly; generating a second portion of the graphical representation indicating the context associated with the subset of computer network events; and generating, based on the first portion and the second portion, the graphical representation of the context report.
14. One or more non-transitory, computer-readable mediums storing instructions that, when executed by a data processing apparatus, cause the data processing apparatus to perform operations comprising those of any of embodiments 1-13.
15. A system comprising one or more processors; and memory storing instructions that, when executed by the processors, cause the processors to effectuate operations comprising those of any of embodiments 1-13.
16. A system comprising means for performing any of embodiments 1-13.

What is claimed is:

1. A system for generating a human-interpretable context report associated with anomalous computer network event logs of users, the system comprising:
one or more processors and non-transitory, computer-readable media comprising instructions that, when executed by the one or more processors, cause operations comprising:
receive a set of data packets over a first computer network, the set of data packets comprising a representation of a computer network events, the computer network events comprising a set of computer network event log entries associated with a first user terminal of a first user;
provide the representation of the computer network events as input to an artificial intelligence (AI) model to generate, via the AI model, (i) a first output indicating a computer network log anomaly associated with the computer network events, (ii) a second output identifying a subset of computer network event log entries that the AI model weighed greater than a threshold weight relative to other computer network event log entries to determine the first output, and (iii) a third output indicating a cluster-derived context description associated with the subset of computer network event log entries, such that the first output, the second output, and the third output are generated via different respective portions of the AI model;
receive, from the AI model, the first output, the second output, and the third output within a threshold time period;
generate, for display on a user interface of the first user terminal, a graphical representation of a context report associated with the computer network log anomaly based on the first output, the second output, and the third output; and
transmit, over the first computer network, the graphical representation of the context report to the first user terminal.

2. A method for generating a human-interpretable context report associated with anomalous computer network event logs of users, the method comprising:
receiving a set of data packets, over a first computer network, comprising a set of computer network events associated with a first user;
providing the set of computer network events as input to an artificial intelligence (AI) model to generate, via the AI model, based on the set of computer network events, (i) a first output identifying a subset of computer network events contributing to an identified anomaly associated with the set of computer network events and (ii) a second output indicating a context associated with the subset of computer network events, the first output being generated via a first portion of the AI model, the second output being generated via a second portion of the AI model that is different from the first portion of the AI model;
receiving, from the AI model, the first output within a threshold time period of the second output;
generating, for display on a user interface of a user device, a graphical representation of a context report associated with the identified anomaly based on the first output and the second output; and
transmitting, over the first computer network, the graphical representation the context report to the user device.

3. The method of claim 2, further comprising:
training a third portion of the AI model during a training routine, the training routine comprising:
providing a first portion of a training dataset as input to the third portion of the AI model, the first portion of training data comprising a second set of computer network event embeddings, wherein each second computer network event embedding of the second set of computer network event embeddings comprises labels indicating (i) a computer network event identifier, (ii) a known anomaly, (iii) a value associated with a respective computer network event embedding, and (iv) a timestamp associated with the respective second computer network event embedding;
generating, based on providing the first portion training data as input to the third portion of the AI model, via the AI model, a third output indicating (i) a third anomaly associated with the second set of computer network event embeddings; and
updating one or more parameters of the third portion the AI model based on comparing the third anomaly associated with the second set of computer network event embeddings to the known anomaly.

4. The method of claim 2, further comprising:
training the second portion of the AI model during a training routine, the training routine comprising:
receiving, for the second portion of the AI model, a hyperparameter value corresponding to a hyperparameter indicating a number of clusters to be generated;
providing a training dataset comprising a second set of computer network embeddings as input to the second portion of the AI model;
generating, based on providing the training dataset as input to the second portion of the AI model, via the second portion of the AI model, a set of clusters, wherein each cluster of the set of clusters includes a subset of embeddings of the second set of computer network embeddings;
determining an embedding metric for each cluster of the set of clusters; and
in response to the embedding metrics for the set of clusters failing to satisfy a threshold embedding metric, updating the hyperparameter of the second portion of the AI model to an updated hyperparameter value, such that the second portion of the AI model generates a second set of clusters, wherein second embedding metrics for the second set of clusters satisfy the threshold embedding metric.

5. The method of claim 2, wherein the subset of computer network events includes one or more computer network events of the set of computer network events that the AI model weighed greater than a threshold weight relative to other computer network events in the set of computer network events.

6. The method of claim 2, further comprising:
determining a set of clusters generated during a training routine by the second portion of the AI model, wherein each cluster of the set of clusters comprises a second set of computer network event embeddings;
receiving, for each cluster of the set of clusters, a user input indicating a respective context corresponding to a respective set of computer network embeddings part of a respective cluster; and
labeling each cluster of the set of clusters with the respective context.

7. The method of claim 2, further comprising:
determining a first cluster generated during a training routine by the second portion of the AI model, the first cluster comprising a second set of computer network event embeddings;
extracting, from the first cluster, the second set of computer network event embeddings;
determining a second set of computer network events corresponding to the second set of computer network event embeddings;
determining, based on the second set of computer network events, for each computer network event of the second set of computer network events, (i) a respective entity identifier associated with a respective computer network event of the second set of computer network events and (ii) a respective value associated with the respective computer network event;
determining, based on the respective entity identifiers and respective values, a respective context for the first cluster; and
labeling the first cluster with the respective context.

8. The method of claim 7, wherein determining the respective context for the first cluster further comprises:
populating a large language model prompt comprising (i) an instruction to generate a domain-specific context based on entity identifiers and values and (ii) the respective entity identifiers and values;
providing the large language model prompt as input to the large language model; and
receiving, from the large language model, the domain-specific context indicating the respective context for the first cluster.

9. The method of claim 2, wherein generating the first output identifying the subset of computer network events further comprises:
generating, based on the set of computer network events, via a third portion of the AI model, a third output indicating the anomaly associated with the set of computer network events;
in connection with generating the third output, determining, via the first portion of the AI model:
a contribution value associated with each computer network event of the set of computer network events;
determining the subset of computer network events contributing to the identified anomaly based on the contribution value of respective computer network events of the set of computer network events satisfying a threshold contribution value; and
generating the first output based on the subset of computer network events contributing to the anomaly.

10. The method of claim 2, wherein generating the second output indicating the context associated with the subset of computer network events further comprises:
determining, for each computer network event of the subset of computer network events, a set of embeddings, wherein each embedding of the set of embeddings correspond to a respective computer network event of the subset of computer network events;
identifying, based on the set of embeddings, a set of clusters associated with the set of embeddings;
determining, based on the set of clusters, a set of labels, wherein each label of the set of labels indicate a first context associated with a respective cluster of the set of clusters; and
generating, based on the set of labels, the second output indicating the context associated with the subset of computer network events.

11. The method of claim 2, wherein the first portion of the AI model comprises an embedding layer and the second portion of the AI model comprises a clustering layer, the method further comprising:
generating, based on the set of computer network events, via the embedding layer of the first portion of the AI model, a set of computer network event embeddings;
providing the set of computer network event embeddings to the clustering layer of the second portion of the AI model to assign each computer network event embedding of the set of computer network event embeddings to respective clusters generated via the clustering layer during a training routine;
in connection with generating the first output, determining a subset of clusters associated with the subset of computer network events; and
generating the second output based on the determined subset of clusters associated with the subset of computer network events.

12. The method of claim 11, wherein generating the second output further comprises:
determining, based on the subset of clusters, a label indicating a first context of embeddings part of a respective cluster of the subset of clusters; and
generating the second output based on the first context.

13. The method of claim 11, wherein generating the second output further comprises:
determining, based on the subset of clusters, a set of labels, wherein each label of the set of labels indicate a first context of embeddings part of a respective cluster of the subset of clusters;
determining, based on the set of labels, a second context and a third context associated with the subset of clusters; and
generating the second output based on the second context and the third context.

14. The method of claim 2, wherein generating the graphical representation of the context report further comprises:
generating a first portion of the graphical representation indicating the identified anomaly;
generating a second portion of the graphical representation indicating the context associated with the subset of computer network events; and
generating, based on the first portion and the second portion, the graphical representation of the context report.

15. One or more non-transitory computer-readable media comprising instructions that, when executed by one or more processors, perform operations comprising:
receiving a set of network events associated with a first user;
providing the set of network events as input to an artificial intelligence (AI) model to generate (i) a first output identifying a subset of network events associated with an anomaly related to the set of network events and (ii) a second output indicating a context associated with the subset of network events, the first output being generated via a first portion of the AI model, the second output being generated via a second portion of the AI model;
receiving, from the AI model, the first output within a threshold time period of the second output; and
generating, for display on a user interface of a user device, a graphical representation of the first output and the second output.

16. The media of claim 15, wherein generating the first output identifying the subset of network events further comprises:
generating, based on the set of network events, via a third portion of the AI model, a third output indicating the anomaly associated with the set of network events;
in connection with generating the third output, determining, via the first portion of the AI model:
a contribution value associated with each network event of the set of network events;
determining the subset of network events contributing to the identified anomaly based on the contribution value of respective network events of the set of network events satisfying a threshold contribution value; and
generating the first output based on the subset of network events contributing to the anomaly.

17. The media of claim 15, wherein generating the second output indicating the context associated with the subset of network events further comprises:
determining, for each network event of the subset of network events, a set of embeddings, wherein each embedding of the set of embeddings correspond to a respective network event of the subset of network events;
identifying, based on the set of embeddings, a set of clusters associated with the set of embeddings;
determining, based on the set of clusters, a set of labels, wherein each label of the set of labels indicate a first context associated with a respective cluster of the set of clusters; and
generating, based on the set of labels, the second output indicating the context associated with the subset of network events.

18. The media of claim 15, wherein the first portion of the AI model comprises an embedding layer and the second portion of the AI model comprises a clustering layer, and wherein the operations further comprise:
generating, based on the set of network events, via the embedding layer of the first portion of the AI model, a set of network event embeddings;
providing the set of network event embeddings to the clustering layer of the second portion of the AI model to assign each network event embedding of the set of network events embeddings to respective clusters generated via the clustering layer during a training routine;
in connection with generating the first output, determining a subset of clusters associated with the subset of network events; and
generating the second output based on the determined subset of clusters associated with the subset of network events.

19. The media of claim 18, wherein generating the second output further comprises:
determining, based on the subset of clusters, a label indicating a first context of embeddings part of a respective cluster of the subset of clusters; and
generating the second output based on the first context.

20. The media of claim 18, wherein generating the second output further comprises:
determining, based on the subset of clusters, a set of labels, wherein each label of the set of labels indicate a first context of embeddings part of a respective cluster of the subset of clusters;
determining, based on the set of labels, a second context and a third context associated with the subset of clusters; and
generating the second output based on the second context and the third context.
